(19) United States
(12) Patent Application Publication
(10) Pub. No.: US 2007/0066166 A1
(43) Pub. Date: Mar. 22, 2007

(54) Stain-resistant and fluid-resistant fabrics and methods of making same

(76) Inventor: Gayron Nixon Davis, Opelika, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/229,790

(22) Filed: Sep. 19, 2005

(51) Int. Cl. B32B 5/02

(52) U.S. Cl. 442/59

(57) ABSTRACT

In one embodiment, a stain-resistant and water-resistant fabric includes a plurality of olefin fibers, a fluoropolymer treatment, and acrylic latex coating(s). Processes for producing the fabric are also disclosed.

### FIELD OF INVENTION(S)

The inventions are generally related to fabrics and methods of preparing fabrics, and more particularly is related to stain-resistant and liquid-resistant fabrics and methods of preparing the same.

### BACKGROUND

Stain resistance, liquid repellency, and resistance to microbial growth are desired characteristics in many uses of textile materials. In the hospitality industry, for example, tablecloths and seating upholstery often lack stain resistance and are subject to rapid spill penetration. These properties necessitate frequent cleaning and/or replacement of such items. Generally, microbial growth is associated with fibers of biologic origin such as cotton, wool, linen, and silk, although with many outdoor uses, the high relative humidity renders even synthetic polymer textiles such as polyesters and polyamides subject to microbial growth.

Various processes may be employed to make water repellant textile fabrics. The term “water repellant” as used herein means essentially impermeable to water, e.g., a treated textile can support a considerable column of water without water penetration through the fabric. Such behavior is sometimes termed “water resistant.” However, the last term generally implies a lesser degree of water repellency and further can be confused with the chemical use of “water resistant” to refer to coatings which are chemically stable to water, or which will not be washed off by water. Water repellent topical treatments are typically incapable of providing the necessary degree of water repellency as that term is used herein.

Waxes and wax-like organic compounds have often been used to provide limited degrees of water repellency. For example, textile fabrics may first be scoured with a soap solution and then treated with a composition that may include zinc and calcium stearates as well as sodium soaps. The long chain carboxylic acid hydrophobic compounds provide a limited amount of water repellency. It is also possible to render fabrics liquid resistant by treating the fabric with commercially available silicones, for example poly(dimethylsiloxane). In tenting fabrics, use is commonly made of paraffin waxes, chlorinated paraffin waxes, and ethylene/vinyl acetate copolymer waxes. Such treated fabrics have a coarse, waxy hand and feel, exhibit little water vapor permeability, and are not resistant to organic solvents.

To overcome problems associated with water absorption and stain resistance, particularly in upholstery materials, resort has been made to synthetic leathers and polyvinylchloride (vinyl) coated fabrics. However, these fabrics do not have the hand or feel of cloth. Moreover, although attempts have been made to render such materials water vapor permeable, these attempts have met with only very limited success, as evidenced by the failure of synthetic leather to displace real leather in high quality seating and footwear.

Although the treating and coating methods discussed previously may assist in rendering the fabric partially liquid and/or stain resistant, the leather-like appearance of some coated fabrics is not desired in many fabric applications. Despite their higher water vapor permeability as compared to earlier generation synthetic leathers, such products are still uncomfortable in many seating upholstery applications.

Applications of relatively small amounts of fluorochemicals, such as TEFLON® fluoropolymer, produced by E. I. DuPont deNemours and Co., and similar compounds also may confer a limited degree of both water resistance and stain resistance, as discussed previously. For optimal water repellency, though, it has proven necessary to coat fabrics' face with thick polymeric coatings that completely destroy the hand and feel of the fabric. Examples include vinyl boat covers, where the fabric is rendered water resistant by application of considerable quantities of polyvinylchloride latex or the thermoforming of a polyvinyl film onto the fabric. The fabric no longer has the hand and feel of fabric, but is plastic-like. Application of polyurethane films in the melt has also been practiced, with similar results. However, unless aliphatic isocyanate-based polyurethanes are utilized, the coated fabric will rapidly weather.

Coatings of polyurethanes or polyurethane ureas have been disclosed in numerous patents and publications. However, the majority of these coatings, such as those previously described, produce fabrics whose hand and feel is not acceptable, e.g., are synthetic leather-like in appearance. Moreover, in producing non-leather-like fabrics coated with polyurethane, polyurethane is typically dissolved into a solvent, and applied to the fabric. Polyurethane lattices also have the disadvantage of being costly polymers, even without the solvent. Unfortunately, it is increasingly difficult to utilize solvent-borne coatings of any kind in both industrial and domestic applications due to pollution laws.

In attempting to resolve some of the deficiencies of the prior art, U.S. Pat. No. 6,024,823 to Rubin et al.; U.S. Pat. No. 6,207,250 to Bullock et al.; U.S. Pat. No. 6,251,210 to Bullock et al.; and U.S. Pat. No. 6,541,138 to Bullock et al. each disclose fabrics, fabrics prepared by certain processes, and methods for preparing fabrics. Each of these patents teaches at least one treatment composition for their fabrics that includes a fluorochemical at a concentration of at least 5 weight percent of the treatment composition. It is noteworthy that in each of these patents, the amount of fluorochemical treating agent used is considerably higher than amounts traditionally used for treating upholstery fabric to render it stain resistant. Some types of fluorochemical present on the fabric face in high concentrations can create a potential health hazard. For example, it has been alleged that some fluorochemicals can be linked to serious health risks, including birth defects, cancer, developmental problems, and high cholesterol, a risk factor for heart attack and stroke. Fluorochemicals are also costly, and increasing the amount used in finishing or coating fabrics adds to manufacturing costs.

Thus, it would be advantageous to develop a fabric that is stain resistant, fluid resistant, and yet uses a low level of fluorochemicals.

### SUMMARY

Disclosed are protective fabrics and methods for making stain resistant and fluid resistant fabrics.

In one embodiment, a stain-resistant, fluid-resistant fabric includes a plurality of inherently stain-resistant olefin fibers forming a fabric having a top and a bottom surface; a fluoropolymer treatment disposed against the bottom surface of the olefin fibers, the fluoropolymer being an aid against coating penetration by the latex backcoating, and the fluoropolymer treatment comprising less than 5% by weight fluoropolymer; followed by single or multiple backcoating(s) disposed upon the fluoropolymer treatment.

In one embodiment, a method includes reducing any yarn lubricants present in or on an olefin fabric; treating the olefin fabric with a fluoropolymer composition, wherein the fluoropolymer composition comprises less than 5 weight percent of the fluoropolymer; baking the fabric a first time; treating the olefin fabric with a first backcoating, wherein the first backcoating comprises an polymer latex and a thickener, but is exclusive of a fluoropolymer; baking the fabric a second time; treating the olefin fabric with a second backcoating, wherein the second backcoating comprises the acrylic latex and the thickener, but is exclusive of the fluoropolymer; baking the fabric a third time; treating the olefin fabric with a third backcoating, wherein the third backcoating comprises the acrylic latex and the thickener, but is exclusive of the fluoropolymer; and baking the fabric a fourth time.

Other fabrics, methods, features, and advantages of the present disclosure will be or become apparent to one with skill in the art upon examination of the following detailed description. It is intended that all such additional fabrics, methods, features, and advantages be included within this description, be within the scope of the present disclosure, and be protected by the accompanying claims.

### BRIEF DESCRIPTION OF THE DRAWINGS

The fabrics and methods of the present disclosure can be better understood with reference to the following drawings. Features shown in these drawings are not necessary drawn to scale.

FIG. 1 is an expanded edge view (cross section) of an embodiment of an example fabric.

FIG. 2 is a flowchart of an embodiment of a process for making the exemplary fabric of FIG. 1.

### DETAILED DESCRIPTION

As is described above, treating the fabric with large amounts of a fluorochemical can significantly increase the stain resistance of most fabrics. As is described in the following, however, the natural stain resistance of olefin fabrics eliminates the need for this large concentration of expensive fluorochemical. Additionally, the application of a special sealant coating, which is placed and adheres to the back of the olefin fabric, renders the composite fabric fluid resistant. Such fabrics are stain resistant and fluid resistant, yet on their face, retain the look and feel, e.g., “hand” of a true fabric.

Although the term “plurality” as used herein with respect to the olefin fibers refer to “multiple” and/or “several,” the term “plurality” as used in this document also refers to the phrase “more than one” (e.g., can mean “two”).

As used herein, the term “olefin” refers to olefin fibers that are manufactured fibers in which the fiber-forming substance is any long-chain synthetic polymer composed of at least 85% by weight of ethylene, propylene, or other olefin units. Olefin fiber is a generic description that covers all thermoplastic fibers derived from olefins, and predominately aliphatic hydrocarbons. Polypropylene (PP) and polyethylene (PE) are the two most common members of the olefin family. For textile fiber uses, the resin for fiber extrusion can be a blend of isotactic and atactic polypropylene so that the fiber can have both sufficient strength and elasticity for the intended use.

The disclosed olefin fibers and yarns are made from extruded melted polymer, with the colorant blended within the melted polymer resin. Thus, the color is inside the fiber, and the yarn finish is applied as the yarn is drawn and spun. Pigment encapsulated olefin fibers can achieve very satisfactory yarn coloration without dyeing or printing. Together with knitting, jacquard, and weaving methods, attractive olefin upholstery patterns can be effectively produced. Disclosed herein are coated upholstery and other fabrics that are produced by combining the naturally stain-resistant olefin fiber with a fluid-resistant backcoating. These fabrics, when applied to furnishings, have the look and hand of fabrics.

The use of olefin yields a more economical product than the established products of polyester, nylon, cotton, rayon, wool, etc. Olefin is a less expensive fiber than common fibers used in upholstery, which are typically saturated with costly fluorochemical treatment compositions to render them stain-resistant, as noted above.

Olefin fibers (e.g., polypropylene and polyethylene) are products of the polymerization of the respective propylene and ethylene gases. For the polymerization s products to be used as fibers, polymerization is carried out under controlled conditions with special catalysts that give chains with few branches. For example, highly purified polypropylene gas (or e.g., ethylene, etc.) is fed into a pressure vessel containing heptane solvent and a Ziegler catalyst (e.g., titanium trichloride or titanium tetrachloride). The temperature and pressure can be held at, for example, about 100° C. and about 100 atmospheres. The reaction continues typically about 8 hours, until the polymer chains grow to a molecular weight of about 80,000, as determined by viscosity.

Olefin fibers are characterized by their resistance to moisture and chemicals. Polypropylene is particularly useful for general textile applications because of its higher melting point. For example, polypropylene has a melting point of 160° C. Colored olefin fibers can be produced by adding pigments directly to the polymer prior to or during melt spinning. A range of characteristics can be imparted to olefin fibers with additives, variations in the polymer, and by use of different process conditions. Additives can be added to alter the fiber's fire resistance, static electricity dissipation, strength, resistance to UV radiation and heat, etc.

Olefin fiber characteristics include an ability to give good bulk and cover; abrasion resistance; colorfastness; quick dry times; low static; resistance to deterioration from e.g., bleaches, chemicals, mildew, perspiration, rot, and weather; thermally bondable; stain and soil resistance; strong sunlight (e.g., UV) resistance; ability to wick body moisture from the skin; very comfortable hand; and very lightweight, with olefin fibers having the lowest specific gravity of all fibers.

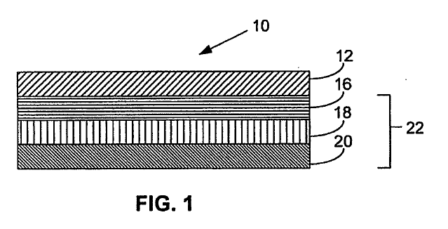

FIG. 1 illustrates an example fabric 10. As is shown in that figure, the fabric 10 comprises a base layer 12. The base layer 12 comprises olefin fibers (the “olefin base layer”). As indicated in FIG. 1, the fabric 10 generally comprises several coatings on the olefin base layer. In the embodiment, the olefin fiber is treated with a fluoropolymer composition. A fluoropolymer composition (not shown) is applied to the olefin base layer 12. The fluoropolymer composition comprises less than about 5 weight percent (“% wt.” or “wt %”) of a fluoropolymer, as will be described in further detail below.

Disposed on the olefin base layer 12 are subsequent backcoatings 22. Backcoatings 22 comprise a plurality of individual layers, for example, of backcoating layer 16, backcoating layer 18, and backcoating layer 20 that are bonded together. Different numbers of backcoating layers than those shown and described herein can be bonded together to form the backcoatings 22. The terms “backcoat”, “backcoating”, or “backcoating layer” as used herein generally refers to a screeded composition applied to the back (rear) side of fabric goods, such as used on carpets and some upholstery. The backcoat layer adds strength and durability while increasing the woven goods structural integrity. The disclosed backcoat layer comprises an acrylic (e.g., and acrylic latex) a thickener or thickening agent, and an antimicrobial agent. Although FIG. 1 depicts three backcoating layers 16, 18, and 20, fewer or more backcoatings can be used. In addition, although FIG. 1 depicts the backcoating layers 16, 18, and 20 as being distinct layers, it should be understood that each layer may form an interpenetrating polymer network, where one layer bonds with a subsequent layer. This is particularly true where the individual coating layers have similarity or identical polymers that might interpenetrate during any baking used to form the layers.

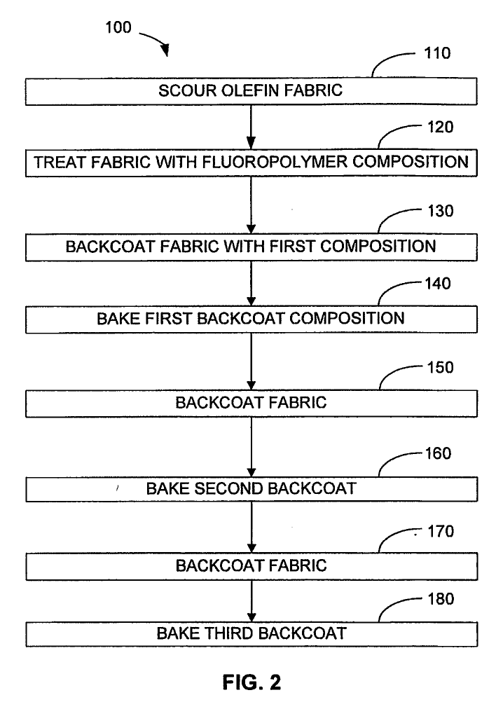

FIG. 2 illustrates an embodiment of a method 100 of producing the fabric 10 of FIG. 1. As shown in block 110, the olefin fabric is processed to reduce or eliminate the presence of oils in or on the fabric. Typically the fabric is scoured in this step. In scouring, the woven fabric is washed in hot water and detergent with agitation and several rinses to, e.g., remove the yarn lubricants, etc. In one embodiment, the fabric is then dried after the scouring (not shown in FIG. 2). Then, in the step shown in block 120, the fabric is treated with a fluoropolymer composition. Although the fabric may be treated with the fluoropolymer composition in a variety of methods (e.g., spin coating, spray or foam coating, roller coating, solvent casting, etc.), pad-vacuum saturation is utilized in a preferred embodiment.

After treating with the fluoropolymer composition, the fabric may then be optionally baked (not shown in FIG. 2). Then, in the step shown in block 130, the fabric is treated with a first backcoat composition. Although the fabric may be treated with the backcoat compositions in a variety of methods (e.g., spin coating, spray or foam coating, roll coating, solvent casting, etc.), doctor blading is utilized in a preferred embodiment. In a preferred embodiment, the fabric is tensioned against a sharp edge, and the coating is s spread onto the fabric as a paste-like material. It should be noted that all the subsequent backcoat compositions are applied to only the back side of the olefin fabric.

After the first backcoat is applied, it is then baked, as shown in block 140. Then, the fabric may be coated and dried multiple times as needed to effect a practical fluid seal for the fabric weave's particular porosity, as shown in exemplary optional steps 150-180. As noted above with respect to FIG. 1, although the process shown in FIG. 2 illustrates the application of three layers of backcoats, fewer or more layers of backcoats can be applied and subsequently baked. The backcoats are typically baked by an oven at a temperature of about 80 to about 155° C. or about 100 to about 125° C. Higher temperatures can be used. The temperature at which the fabric begins to shrink is the upper limit of the temperature range that can be used to bake the backcoats.

Although the fabrics have been described herein thus far as generally useful for upholstery, other garments/uses may benefit from the fabrics and methods described herein. Such garments may include one or more of shirts, pants, jackets, coveralls, vests, and the like that are intended for use in various applications. Moreover, the present disclosure is not limited to garments and upholstery. More generally, the present disclosure pertains to stain-resistant, fluid-resistant fabrics, irrespective of their application.

As noted above, the base olefin layer is treated with a composition that comprises a fluoropolymer. The term “fluoropolymer” as used herein covers a whole family of resins and elastomers. All the fluoropolymers include fluorine, and the bulk of these high-performance materials are fluorocarbon (plastics) resins, mostly analogs of ethylene such as polytetrafluoroethylene, polymers of chloro-trifluoroethylene, fluorinated ethylene, etc. Another group of fluoropolymers with a different set of properties beyond high-temperature resistance and chemical resistance are the fluoroelastomers. One group of fluoroelastomers, for example, is the polyfluorosilicones. Both the fluorocarbon resins and fluoroelastomers can be homopolymers or copolymers.

In addition, another category of fluoropolymers can be used. These are low-molecular-weight materials with a fluorine base, with varying chemical structure and functional advantages that go beyond the original fluoropolymers. A final category of fluoropolymers is made up of a series of miscellaneous products that include chlorotrifluoroethylene (CTFE) fluids, perfluoromembrane surfactants, fluoropolymer composites, and developmental materials. Any one or more types of the fluoropolymer can also be used in combination with the fluoropolymer composition, including a mixture of fluoropolymers.

Thus, the fluoropolymer family of resins, elastomers, and miscellaneous fluorine-based plastic materials that can be used in accordance with the disclosed compositions and processes include, for example but not limited to, the following resins: chlorotrifluoroethylene-vinylidene fluoride copolymer (CTFE1VDF), ethylene-chlorotrifluoroethylene copolymer (ECTFE), ethylene-tetrafluoroethylene (ETFE), fluorinated ethylene-propylene copolymer (copolymer FEP), polychlorotrifluoroethylene (PCTFE), perfluoroalkyl-tetrafluoroethylene copolymer (PFA), polytetrafluoroethylene (PTFE), polyvinylidene fluoride (PVDF), polyvinyl fluoride (PVF), and tetrafluoroethylene-hexafluoropropylene copolymer (TFE/HFP). Also included are the following elastomers: hexafluoropropylene-vinylidene fluoride copolymer (HFP/VDF), tetrafluoroethylene-propylene copolymer (TFE/P), and tetrafluoroethylene-perfluoromethylether copolymer (TFE/PFMe), and combinations thereof. Examples of commercially available fluoropolymers suitable for use in the disclosed fluoropolymer compositions include ZONYL® and TEFLON® fluoropolymers, from DuPont de Nemours & Co. of Wilmington, Del. US and SCOTCHGARD® product from 3M of St. Paul, Minn., US.

The fluoropolymer treatment composition includes less than 5 wt % fluoropolymer(s). In one embodiment the fluoropolymer comprises less than or equal to about 1.5 wt % fluoropolymer. In one embodiment, the fluoropolymer composition is an aqueous composition and the remainder of the fluoropolymer composition is water and, optionally, a latex polymer or copolymer.

The fluoropolymer in the disclosed fluoropolymer composition also serves as a process aid to inhibit the first layer of backcoating from flowing into the fabric surface too deeply, which would stiffen the fabric. In addition, by applying the fluoropolymer composition first, before the subsequent backcoatings that lack a fluoropolymer, as depicted in FIG. 2, aids in the formation of a first layer of backcoat that is a thin, more continuous film of latex polymer for rendering the fabric more fluid-resistant. Thus, the fluoropolymer is present in lesser amounts than taught by others, as discussed above. The fluoropolymer need not increase the stain resistance of the fabric to any appreciable degree because the olefin fabric is already normally stain resistant. The relatively small amount fluoropolymer used in the disclosed compositions for treating the fabric is utilized to place the acrylic latex polymer in the subsequent coatings on the surface, for best softness and fluid sealing of the fabric.

The aqueous backcoatings that are applied subsequent to the fluoropolymer composition include an acrylic latex polymer in amount of about 20 to about 80 wt %.

The polymer latex comprises a dispersion of polymers and/or copolymers of acrylic or acrylate functional monomers, optionally copolymerized with other ethylenically unsaturated monomers. The nature of the monomers from which the polymer particles of the copolymer latex can be formed can be adjusted by one skilled in the art to provide the properties that are desired of the coated fabric. Preferably, the latex particles are acrylate copolymers, e.g., copolymers formed from lower alkyl acrylates such as methylacrylate, ethylacrylate, butylacrylate, methylmethacrylate, and the like, as well as additional copolymerizable monomers such as vinyl acetate, acrylonitrile, styrene, acrylic acid, acrylamide, N-methylacrylamide, and urethane acrylates. The presence of crosslinkable groups such as acrylamide and N-methylacrylamide along the polymer backbone is preferred. Terpolymers of styrene, methylacrylate, and ethylacrylate are very suitable. Some preferred copolymers include WRL1084, a styrene, methylacrylate, ethylacrylate copolymer containing N-methylacrylamide in the polymer backbone available from B.F. Goodrich, and HYCAR® 1402 from the same source. The copolymer lattices are available in varying solids contents, for example, from 30 to 60 wt %, which are then added to formulating water to provide the desired solids content in the backcoating composition. It is sometimes advantageous that the particles constituting the acrylic latex solids should have a glass transition temperature less than about 50° C., preferably in the range of −30 to 35° C., most preferably about −10° C. Copolymers having glass transition temperatures appreciably below −10° C. may give the composite fabric backing a tacky “hand.” Preferably, the surfactant content of the latex is as low as possible to provide for good fluid repellency and fluid resistance.

Additionally, the backcoat compositions include a thickener that raises the viscosity of the backcoat composition to, for example, about 20,000 to about 90,000 centipoise, or about 50,000 centipoise. A thickener is added to the backcoat composition to enable the backcoating compositions to spread as a thick paste. This prevents the coating compositions from wicking into the olefin yarns, causing loss of softness, but instead fills and seals interstices between the fibers. It is undesirable for the coating to penetrate too far down into the fabric so that the fabric can retain a flexibility and soft “hand.” Examples of thickeners that can be used in the disclosed coating compositions include, but are not limited to water soluble, generally high molecular weight natural and synthetic materials, particularly the latter. Examples of natural thickeners include, but are not limited to, the various water soluble gums such as gum acacia, gum tragacanth, guar gum, and the like. More preferred are the chemically modified celluloses and starches, such as methylcellulose, hydroxymethylcellulose (e.g., Hercules NATRASOL™ brands), propylcellulose, and the like. Most preferred are high molecular weight synthetic polymers such as polyacrylic acid; copolymers of acrylic acid with minor amounts of copolymerizable monomers such as methyl acrylate, methacrylic acid, acrylonitrile, vinylacetate, and the like (e.g., Rhom and Haas Company's (Philadelphia, Pa., US) ACRYSOL® or Parachem Southern Inc.'s (Greenville, S.C., US) PARAGUM™ brands), as well as the salts of these compounds with alkali metal ions or ammonium ions; polyvinylalcohol and partially hydrolyzed polyvinylacetate (e.g., Air Products and DuPont's ELVANOL™ brand); polyacrylamide; polyoxyethylene glycol; and the so-called associative thickeners such as the long chain alkylene oxide capped polyoxyethylene glycols and polyols or their copolymer polyoxyethylene/polyoxypropylene analogues. The length of the carbon chain of the long chain alkylene oxide in associative thickeners has a great effect on the thickening efficiency, with alkylene residues of 8-30 carbon atoms, preferably 14-24 carbon atoms having great thickening efficiency. The thickeners are preferably used in amounts up to about 5 wt %, and more preferably about 1 to 3 wt %. The thickener solids are water soluble in the amounts used.

Even though the olefin fabric may already be pigmented by weaving pigmented yarns, any one of the compositions can include additional, optional color, or pigment.

Further, both the fluoropolymer compositions and the backcoatings can include an optional antimicrobial agent. The antimicrobial agent is present in an antimicrobially-effective amount, and comprises preferably about 0.10 to about 4 wt % of the composition, or from about 0.20 to about 2 wt %, or from about 0.20 to about 1 wt %, or about 1 wt %. The term “antimicrobial agent” refers to any substance or combination of substances that kills, retards, or prevents the growth of a microorganism, and includes antibiotics, antifungal, antiviral, and antialgal agents. Examples of antimicrobial agents are ULTRA FRESH™ DM-25, ULTRAFRESH™ DM-50 and ULTRAFRESH™ UF-40 available from Thomas Research Associates of Toronto, Ontario, Canada, and INTERSEPT®, available from Interface Inc., Georgia, US. Another preferred antimicrobial agent is AMICAL® FLOWABLE, available from Angus Chemical Co. of Northbrook, Ill., US. Other antimicrobials, particularly fungicides, may be used. Examples are various tin compounds, particularly trialkyltin compounds such as tributyl tin oxide and tributyl tin acetate, copper compounds such as copper 8-quinolinolate, metal complexes of dehydroabietyl amine and 8-hydroxyquinolinium 2-ethylhexoate, copper naphthenate, copper oleate, and organosilicon quaternary ammonium compounds.

### EXAMPLES

Table 1 below demonstrates the results of various tests performed on an exemplary embodiment of the disclosed fabrics. The embodiment of the disclosed fabrics that was tested and achieved the results in the following Tables was prepared by immersing and saturating a clean polypropylene fabric in a dilute fluoropolymer composition/dispersion, and then extracting the excess before drying off the water. This leaves a thin film of fluoropolymer on the fibers (e.g., to later minimize latex paste penetration). The fluoropolymer composition/dispersion used was NK-GUARD™ NF-153, manufactured by and commercially available from Nicca Chemical Co., Ltd. of Fukui, Japan. NK-Guard™ NF-153 is a 30% solids dispersion as used for the following tests. The NK-Guard™ NF-153 composition/dispersion was further diluted to 6.5% (=2.0% solids), and then applied at a rate of 50% on the weight of the dry fabric (owf). This yields about 3.2% of NK-Guard™ NF-153 (which=1.0% solids) owf. A latex backing was applied to the embodiment of the disclosed fabrics test below. A “ready to coat” mixture of acrylic latex, thickener, defoamer, coating aids, cross-linker, antimicrobial agent, and other additives was applied to the fabric that had been treated with the fluoropolymer dispersion. The acrylic latex mixture applied as the backcoating was PERFORMAX™ 3836, manufactured by and commercially available from Noveon, Inc. of Gastonia, N.C., USA. The acrylic latex coating is about 45% solids by weight. It has been determined that the PERFORMAX™ 3836 acrylic latex composition exhibits ready adhesion to the treated polypropylene fabric.

In the water vapor transmission (WVT) test, 1.0 square-meter of the disclosed coated fabric transpires about 326 grams of water as vapor through the fabric in 24 hours. The WVT is a measure of the “breathability” of the fabric.

TABLE 1
Properties of an Embodiment of a Disclosed Fabric

SAMPLE IDENTIFICATION:
BOTANICA ™
PERFORMANCE FINISH

| | Machine | Cross |
|---|---|---|
| | Direction | Direction |
| TEAR RESISTANCE | 23.3 lbs. | 29.2 lbs |
| TRAPEZOID METHOD | | |
| CFFA-16c | | |
| TENSILE STRENGTH & | | |
| ELONGATION CFFA-17 | | |
| Grab Method | | |
| Breaking Strength | 251 lbs | 226 lbs |
| Elongation @ 15 lbs. | 2.67% | 4.85% |
| DRAPE STIFFNESS | | |
| ASTM D 1388 | | |
| Bending Length | 1.53″ | 1.48″ |
| WATER VAPOR | | |
| TRANSMISSION (WVT) | | |
| ASTM E 96, METHOD B | | |
| 73.4°., 50% RH | | |
| (Rel. Humidity) | | |
| g/24 h · m² | 326 | |

Table 2 below demonstrates the results of various tests performed on an exemplary embodiment of the disclosed fabrics versus a known prior art fabric with respect to stain resistance. The disclosed fabric tested was made according the description above. The “prior art” fabric tested is similar to that described in U.S. Pat. No. 5,565,265 issued to Rubin. The prior art fabric tested was 100% polyester fiber, treated with a fluoropolymer composition (e.g., probably treated with about 6 to 12% of a fluoropolymer composition) as the stain repellent step. Next, the stain repellent treated polyester was coated with latex paste and dried and cured to seal the fabric against penetration by liquids. The fabric was then transfer printed.

In every case (except UFAC flammability) the top rating in terms of quality is Class 5; the lowest is Class 1. For example, the following ratings apply for stain release ratings after cleaning: Class 5 signifies no staining; Class 4 signifies slight staining was visible; Class 3 signifies only fair stain release; Class 2 signifies moderate staining; and Class 1 signifies poor stain release.

Pilling also is best at Class 5. For example, after the tumble test, the fabric was s compared to 5 photographic standards showing various populations of tiny fiber balls (pills), of which the Class 5 photo shows almost none.

Colorfastness to fading in light also is best at Class 5 (no fading). Class 1 indicates severe color change after 40 hours of accelerated (intense) exposure to light.

The UFAC (Upholstered Furniture Action Committee) flammability test has only two classes. Class 1 is a pass and Class 2 indicates a failure.

TABLE 2
Stain Resistance of an Embodiment of a Disclosed
Fabric Compared to Prior Art Fabric

| | Disclosed Embodiment | Prior Art Fabric |
|---|---|---|
| Blood Stain | Class 5 | Class 4 |
| Iodine Stain | Class 5 | Class 4 |
| Milk Stain | Class 5 | Class 5 |
| Cola | Class 5 | Class 4 |
| Black Coffee | Class 5 | Class 5 |
| Urine | Class 5 | Class 5 |
| Ketchup | Class 5 | Class 4 |
| Mustard | Class 5 | Class 4 |

Table 3 below demonstrates the results of various tests performed on an exemplary embodiment of the disclosed fabrics versus a known prior art fabric with respect to various properties of the respective fabrics. Tensile, tear, and seam slippage are all in pounds of force required for destruction. Abrasion is rated in cycles of double rubs on the same spot with a wire screen needed to destroy one yarn.

TABLE 3
Properties of an Embodiment of a Disclosed
Fabric Compared to Prior Art

| | Disclosed | | |
|---|---|---|---|
| | Embodiment | Prior Art | Characteristics |
| Tensile | 260/311 | 270/238 | Pounds of force |
| | | | to break a strip |
| Tear | 30/48 | 30/40 | Pounds of force |
| | | | to tear |
| Seam Slippage | 93/75 | 100/80 | |
| Abrasion | 50,000+ | 50,000 | Double rubs with |
| | | | a wire screen |
| Pilling | Class 5 | Class 4 | Described above |
| Colorfastness | Class 5 | Class 4 | Described above |
| Hydrostatic (Sutter) | 100 avg. | 100 avg. | Resistance to |
| | | | water penetration |
| Bacteria Resistance | 100% | n/a | |
| Ufac | Class 1 | Class 1 | Flame resistance |
| Calf. 117 E | Pass | Pass | Flame resistance |
| NFPA 260 | Pass | Pass | Flame resistance |

Table 4 below demonstrates the results of various antimicrobial tests performed on an exemplary embodiment of the disclosed fabrics. The disclosed fabric was treated with an antimicrobial composition, namely ULTRA-FRESH® DM-50 antimicrobial composition manufactured by and commercially available from Kroy Int'l. Inc. of Toronto, Ontario, Canada. The bacterial test was staphylococcus. The “growth-free zone” refers the width of the growth-free zone surrounding the test specimen, i.e., staph could not grow near the treated area. The term “contact inhibition” refers to the percentage of bacteria-free area under the test specimen, i.e., staph could not grow on the treated area.

TABLE 4
Properties of an Embodiment of a Disclosed
Fabric Compared to Prior Art

| | | | CONTACT |
|---|---|---|---|
| SAMPLE | GROWTH-FREE | | INHIBITION |
| DESCRIPTION | ZONE (mm) | | (%) |
| 1147383 Vega ™ | face | 10 | 100 |
| | backing | 9 | 100 |
| 1147386 Pebbles ™ | face | >15 | 100 |
| | backing | >15 | 100 |
| 1147387 Confetti ™ | face | 14 | 100 |
| | backing | 8 | 100 |
| 1147388 Puzzle ™ | face | 10 | 100 |
| | backing | 8 | 100 |

All ratios, concentrations, amounts, and other numerical data may be in some instances expressed herein in a range format. It is to be understood that such a range format used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5% by weight” should be interpreted to include not only the explicitly recited concentration of about 0.1 wt % to about 5%, but also include individual concentrations (e.g., 1%, 2%, 3%, and 4%) and the sub-ranges (e.g., 0.5%, 1.1%, 2.2%, 3.3%, and 4.4%) within the indicated range.

In addition, the above-described embodiments of the present disclosure, particularly any “preferred” embodiments, are merely possible examples of implementations, and are merely set forth for a clear understanding of the principles of the disclosure. Many variations and modifications can be made to the above-described embodiment(s) without departing substantially from the principles of the disclosure. All such modifications and variations are intended to be included herein within the scope of this disclosure and protected by the following claims.

1. A stain-resistant, liquid-resistant fabric, comprising:
a plurality of olefin fibers forming a fabric having a top and a bottom surface;
a fluoropolymer treatment composition on the olefin fibers, the fluoropolymer treatment composition comprising less than 5% by weight fluoropolymer, whereby the fluoropolymer treatment composition forms a repelling surface against subsequent process coating penetration; and
one or more backcoatings disposed upon only one side of the fabric, the backcoating forming a seal layer against liquid penetration from a top surface of the backcoating through a bottom surface of the backcoating.

2. The fabric of claim 1, wherein the olefin fibers are chosen from at least one of the following: polypropylene, polyethylene, or any long chain synthetic polymer composed of at least 85% by weight of any olefin units, and combinations thereof.

3. The fabric of claim 1, wherein the fabric patterns and color are created by weaving colored or white olefin yarns whose fibers were dyed prior to or during melt spinning.

4. The fabric of claim 1, wherein stain resistance is imparted to the fabric via the olefin fibers.

5. The fabric of claim 1, wherein the fluoropolymer treatment prepares the fabric for a subsequent latex back coating.

6. The fabric of claim 1, wherein the backcoating comprises a thickener that increases the viscosity of the backcoating to 10,000 to 90,000 centipoise.

7. The fabric of claim 1, wherein the backcoating comprises a thickened latex polymer.

8. The fabric of claim 7, wherein the latex back coating further comprises at least one of the following additives: a thickener, a colorant, a pigment, an antimicrobial agent, a static electricity dissipater, a fire retardant, a strengthening aid, a heat retardant, a UV-inhibitor, and combinations thereof.

9. The fabric of claim 1, wherein the fluoropolymer treatment further comprises a thickener that increases the viscosity of the fluoropolymer coating to at least about 50,000 centipoise.

10. The fabric of claim 1, wherein the fluoropolymer is chosen from at least one of the following: chlorotrifluoroethylene-vinylidene fluoride copolymer (CTFE/VDF), ethylene-chlorotrifluoroethylene copolymer (ECTFE), ethylene-tetrafluoroethylene (ETFE), fluorinated ethylene-propylene copolymer (copolymer FEP), polychlorotrifluoroethylene (PCTFE), perfluoroalkyl-tetrafluoroethylene copolymer (PFA), polytetrafluoroethylene (PTFE), polyvinylidene fluoride (PVDF), polyvinyl fluoride (PVF), and tetrafluoroethylene-hexafluoropropylene copolymer (TFE/HFP), hexafluoropropylene-vinylidene fluoride copolymer (HFP/VDF), tetrafluoroethylene-propylene copolymer (TFE/P), and tetrafluoroethylene-perfluoromethylether copolymer (TFE/PFMe), and combinations thereof.

11. A process for producing a stain-resistant, water-resistant fabric, the process comprising the steps of:
reducing any lubricants present in or on an olefin fabric;
treating the olefin fabric with a fluoropolymer composition, wherein the fluoropolymer composition comprises less than 5 weight percent of a fluoropolymer;
baking the fabric a first time;
treating the olefin fabric with a first backcoating, wherein the first backcoating comprises a polymer latex and a thickener;
baking the fabric a second time;
treating the olefin fabric with a second backcoating, wherein the second backcoating comprises the polymer latex and the thickener; and
baking the fabric a third time; and
treating the olefin fabric with a third backcoating, wherein the third backcoating comprises the polymer latex and the thickener; and
baking the fabric a third time.

12. The process of claim 11, wherein the fluoropolymer composition comprises less than or equal to approximately 1.5 weight percent of the fluoropolymer.

13. The process of claim 11, wherein the thickener increases the viscosity of the backcoating latex to about 50,000 centipoise.

14. The process of claim 11, wherein each coating is applied to only one side of the olefin fabric by doctor blading or other coating means.

15. The process of claim 11, wherein at least one of the coatings further comprises at least one of the following: a thickener, a colorant, a pigment, an antimicrobial agent, a static electricity dissipater, a fire retardant, a strengthening aid, a heat retardant, a UV-inhibitor, and combinations thereof.

16. The process of claim 15, wherein the antimicrobial agent comprises about 1% by weight of the coating composition, and wherein the antimicrobial agent is chosen from at least one of the following: a fungicide, a germicide, an antibacterial agent, a virucide, an antibiotic, and combinations thereof.

17. The process of claim 11, wherein the olefin fabric comprises an olefin chosen from at least one of the following: polypropylene, polyethylene, and copolymers and combinations thereof.

18. The process of claim 11, wherein the olefin fabric comprises an olefin product of the polymerization of propylene or ethylene gases, wherein the polymerization is carried out under controlled conditions with catalysts that yield olefin chains with few branches.

19. The process of claim 11, wherein the olefin fabric comprises colored olefin fibers that are produced by adding a dye directly to the olefin prior to or during melt spinning.

20. A fabric produced by the process of claim 11, wherein the fluoropolymer comprises less than or equal to approximately 1.5 weight percent of the fluoropolymer coating.

21. The fabric of claim 20, wherein the thickener increases the viscosity of the backcoating(s) to about 50,000 centipoise.

22. The fabric of claim 21, wherein the latex backcoating effectively seals the fabric composite against liquid penetration, but over time, does transpire moisture vapor out which may have been trapped inside an upholstered cushion due to a leaking seam.
